(19) United States
(12) Patent Application Publication
(10) Pub. No.: US 2016/0063496 A1
(43) Pub. Date: Mar. 3, 2016

(54) Remote Secure Transactions

(71) Applicants: Vijay Kumar Royyuru, Norristown, PA (US); Brent Dewayne Adkisson, Omaha, NE (US); Daniel Carnes, Bellevue, NE (US); Paul Johannesen, West Chester, PA (US); Robert Klotz, Lafayette Hill, PA (US); Brian Kean, Missouri Valley, IA (US)

(72) Inventors: Vijay Kumar Royyuru, Norristown, PA (US); Brent Dewayne Adkisson, Omaha, NE (US); Daniel Carnes, Bellevue, NE (US); Paul Johannesen, West Chester, PA (US); Robert Klotz, Lafayette Hill, PA (US); Brian Kean, Missouri Valley, IA (US)

(21) Appl. No.: 14/784,542

(22) PCT Filed: Feb. 27, 2014
(86) PCT No.: PCT/US2011/019024

§ 371 Date: Oct. 14, 2015

(51) Int. Cl. G06Q 20/40; G06Q 20/20; G06Q 20/38; H04L 9/32; H04L 29/06

(52) U.S. Cl. CPC G06Q 20/405; H04L 9/3226; H04L 63/0442; H04L 63/045; G06Q 20/3829; G06Q 20/204; G06Q 20/385

(57) ABSTRACT

Embodiments of the disclosure can provide systems, methods, and apparatus for remote secure transactions. In one embodiment, a payment processing system can be provided, which can include a network interface communicating with a memory, the memory communicating with a processor for executing payments, and the processor, when executing a computer program, performing operations. The operations can include storing, by the processor and to a memory associated with the payment processing system, account information associated with the consumer mobile system, and receiving, by the processor and from a consumer mobile device, a request, wherein the request comprises an account identifier associated with the consumer mobile device. The operations can also include validating, by the processor and from a consumer mobile device, the consumer mobile device based at least in part on the account identifier, and sending, by the processor, payment processing data, based on the validation.

### RELATED APPLICATIONS

The present application is a national stage of PCT/US2014/019024, filed on Feb. 27, 2014, and published as WO 2014/149498, which claims priority to U.S. Ser. No. 61/800,422, titled “Remote Secure Transactions,” filed Mar. 15, 2013, the contents of which are hereby incorporated by reference.

### TECHNICAL FIELD

Embodiments of the present disclosure relate generally to generating secure transactions and more specifically to system, methods, and apparatus for remote secure transactions.

### BACKGROUND

Many non-cash payment instruments are utilized to complete payment transactions. Examples of conventional payment instruments can include checks, stored value cards, credit cards, debit cards, and the like. In a typical payment transaction, a customer can present a payment instrument to a merchant at a point of sale, and the merchant can collect information, including an account number, from the payment instrument. The account number typically is transmitted along with other transaction information, such as a transaction amount, to a transaction processor for approval. The transaction processor can make a determination as to whether the payment transaction is to be accepted or declined and, in response, can transmit an approved or declined message to the merchant.

### BRIEF SUMMARY OF THE DISCLOSURE

Other embodiments, systems, methods, computer-readable media, aspects, and features of the disclosure will become apparent to those skilled in the art from the following detailed description, the accompanying drawings, and the appended claims.

In one aspect, the disclosure can utilize OEAP Padding and RSA Encryption with a Public Key for encryption of a consumer-entered security credential (e.g., a personal identification number (PIN), such as an mPIN). In addition, the disclosure can transport an encrypted form or instance of the consumer-entered security credential from a payment transaction module to an account transaction service (ATS) hardware secure module (HSM). As a result, for example, the disclosure does not permit the consumer-entered security credential (e.g., an mPIN) to be available as clear information (e.g., clear text data) for intermediary components, such as a payment infrastructure (e.g., a wallet infrastructure) or an ATS.

In another aspect, the disclosure can utilize or otherwise leverage the ATS HSM to translate or otherwise transform the consumer-entered security credential (e.g., a PIN, such as an mPIN) from an encrypted form or instance of such credential in accordance with (e.g., generated according to) OEAP Padding and RSA Encryption with asymmetric keys to another encrypted form or instance in accordance with (e.g., generated according to) ANSI PIN Block 3DES encryption with symmetric keys. Such translation or transformation can permit connecting at least two domains with distinctly different security threats and cryptography abilities in the same transaction. Such domains can be referred to as security domains. It should be appreciated that a consumer mobile device is not a safe environment to save symmetric keys. Yet, such device can be configured to or is otherwise capable of storing and/or encrypting with asymmetric public keys. In addition, a processing and validation platform, such as an issuer or a dynamic track cryptogram (DTC) processor can be the platform that performs PIN validation for a conventional magnetic stripe card based at least in part on point-of-sale (POS) transactions and the PIN(s) associated with such transactions and entered on a merchant's PIN pad. Such issuer processors can be configured to or be otherwise capable of storing and/or validating PIN(s) using or otherwise leveraging 3DES symmetric keys that result in 3DES encrypted ANSI PIN Blocks. In certain embodiments, by having the ATS issue a public key to the consumer mobile phone and accept a 3DES symmetric key from the processing and validating platform (e.g., an issuer processor (via, for example, the ATS HSM rather, since the keys may not be available in the clear), the ATS or a component thereof can be configured to or be otherwise capable of connect or coupled such two disparate security domains and transport the consumer-entered security credential (e.g., a PIN, such as mPIN) securely from the consumer mobile phone all or substantially all the way to the processing and validation platform (e.g., an issuer processor), without the consumer-entered security credential (e.g., an mPIN) ever being available in clear text to any intermediary components or functional elements. More generally, such transformation functionality or mechanism can be utilized or otherwise leveraged to connect and transport any data across multiple security domains with need for combining asymmetric key and symmetric key cryptography.

The encrypted security credential received at a first computing device, e.g., from a second computing device, can be decrypted to obtain a clear text value using the security key established between the first and second computing devices. In one aspect, the clear text value can be then used by the first computing device, using a new security key, to generate a second security credential. The difference in security protocols and security keys used for the first security credential and the second security credential, in combination with the use of a single command, for example, within a HSM at the first computing device for such entire operation can result in the first computing device performing a translation function of the first encrypted security credential to the second encrypted security credential.

In yet another aspect, the disclosure permits conveyance of a security credential (e.g., an mPIN) within the DTC portion of a Track 1 for a processing and validation platform (e.g., an issuer processor) to validate a payment transaction associated with the security credential, without utilization of a separate PIN Block data element in the transaction in order to convey the security credential (which can be entered by a consumer).

In still another aspect, the disclosure can implement tokenization as a service, without a secure element, that can create dynamic track data, including a security credential (e.g., an mPIN) in a DTC, that can appear as the same as the Dynamic Tracks that would have been produced if the secure element were being used. Such functionality can permit a processing and validation platform (e.g., an issuer processor) to validate the transaction the same way, including validation of the security credential (e.g., an mPIN) regardless of where the tokenized dynamic track data was created—e.g., either via a secure element or via a service.

### BRIEF DESCRIPTION OF THE DRAWINGS

Reference will now be made to the accompanying drawings, which are not necessarily drawn to scale, and wherein:

FIG. 1 illustrates a schematic block diagram of an example system for facilitating secure payment transactions, according to at least one embodiment of the disclosure.

FIG. 2A illustrates a schematic block diagram of an example consumer mobile device for facilitating secure transactions, according to at least one embodiment of the disclosure.

FIG. 2B illustrates a schematic block diagram of an example consumer mobile device configured with encrypted hardware, according to at least one embodiment of the disclosure.

FIGS. 3-5 illustrate example methods in accordance with at least certain aspects of the disclosure.

### DETAILED DESCRIPTION

Illustrative embodiments of the disclosure will now be described more fully hereinafter with reference to the accompanying drawings, in which certain embodiments of the disclosure are presented. The disclosure may be embodied in many different forms and should not be construed as limited to the embodiments set forth herein. Like numbers refer to like elements throughout. In accordance with embodiments, the disclosure provides systems, devices, apparatuses, and techniques for permitting or otherwise facilitating secure transactions, including financial and commercial transactions, such as secure payment transactions utilizing a mobile device. The secure transactions can include communication (e.g., transmission, reception, or exchange) of information indicative or otherwise representative of one or more parties and/or one or more of goods, services, or funds related to at least one of the party(ies). In certain embodiments that secure transactions can include financial transactions, commercial transactions, and the like. Yet, it should be appreciated that other types of secure transactions also are contemplated.

As used in the present disclosure, the terms “payment transaction” may refer to any transaction that may be made by a consumer using a payment instrument (such as a payment account). One example of a payment transaction can be a purchase transaction. Additionally, the terms “payment transaction,” “transaction,” “purchase transaction,” and “cashless transaction” may be used interchangeably unless expressly disclosed otherwise and/or prevented by specific functionality or context associated with specific embodiments.

As used in the present disclosure, the term “payment account” may refer to any suitable account that may be utilized to facilitate and/or complete a payment transaction. Examples of payment accounts include, but are not limited to, credit card accounts, debit card accounts, stored value accounts, and gift card accounts. The terms “payment account,” “account,” and “transaction account” may be used interchangeably unless expressly disclosed otherwise and/or prevented by specific functionality or context associated with specific embodiments.

In accordance with certain embodiments of the disclosure, systems, devices, apparatuses, and techniques for remote secure transactions may be provided. In other example embodiments, systems, devices, apparatuses, and techniques for enabling or otherwise facilitating secure transactions using a mobile device can be provided. In any instance, typically, consumers may have payment information in the form of credit cards or debit cards. In certain scenarios, for example, in response to payment to a merchant, a magnetic stripe on a credit card or a debit card can be scanned by a point-of-sale (POS) device operated by the merchant. The magnetic stripe may contain one or more tracks, at least one or each of the track(s) having the ability (e.g., being configured or otherwise assembled and/or programmed) to store or retain information (such as data, metadata, and/or signaling). The magnetic stripe may retain banking information and/or user account information. A POS reader device (also referred to as a POS reader) may scan or otherwise access the information on the credit card or the debit card, and can transmit at least a portion of such information to a transaction server. The transaction server may authorize payment to the merchant based at least on the information that is transmitted.

Many consumers have mobile devices, which may be leveraged or otherwise utilized to store payment information. However, there may be some risks associated with storing payment information on consumer mobile devices. Many consumer mobile devices are configured to have Internet communications, and therefore, they may be vulnerable to third-party attacks into the system. Further, if all or a substantive portion of the payment information is stored on a consumer mobile device, a theft of the mobile device may compromise the security of the consumer's payment accounts.

Embodiments of the present disclosure may provide for systems, devices, apparatuses, and techniques for leveraging consumer mobile devices to be utilized for secure payment transactions.

In at least one embodiment, a consumer mobile device may be configured to locally store payment information. Embodiments of the present disclosure may provide for systems, methods, and apparatus for creating, managing, and utilizing a security code for the consumer mobile device with respect to the stored payment information.

The transaction information may be received in a wide variety of ways. For example, transaction information may be received from a tone transmission device. As another example, transaction information may be received from a POS device, which may or may not be a tone transmission device. The mobile device may generate a request to approve a proposed transaction, and the generated request may be communicated to a transaction processor. The generated request may include an identifier associated with the mobile device and at least a portion of the received transaction information, for example, a transaction amount and an identifier associated with a POS device or a merchant. The transaction processor may determine whether to approve or deny the proposed transaction. Based at least in part on the determination, the transaction processor may communicate an approval or decline indication to the POS terminal or to another system, device, or network component associated with the merchant. In accordance with an aspect of disclosure, a proposed transaction is requested by a mobile device rather than by a merchant. In this regard, sensitive information, for example, account information associated with a consumer, may be safeguarded.

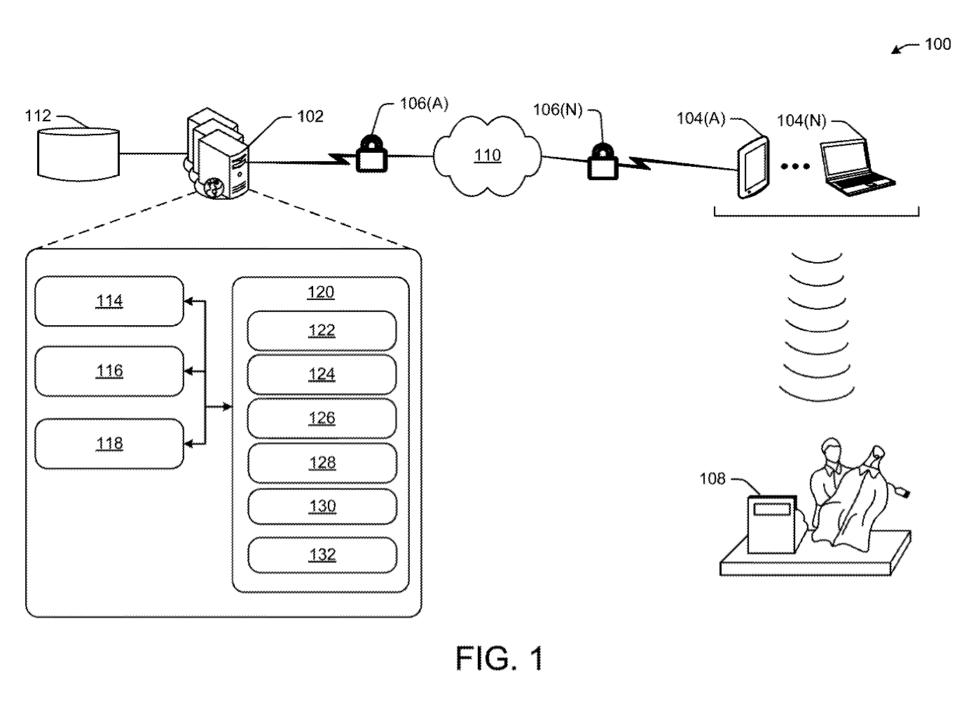

FIG. 1 is a schematic block diagram of a system for facilitating remote transactions. The system 100 may comprise a service provider system 102, which may include any number of financial institution systems. As shown in FIG. 1, the system 100 may include one or more service provider systems 102(a) . . . 102(n) (herein referred to as 102) and/ or one or more consumer mobile devices 104(A) . . . 104(N) (herein referred to as “consumer mobile device 104”).

The service provider system 102 may include any number of issuers and/or financial institution systems. An issuer system may facilitate the backend processing of a proposed transaction. For example, an issuer system may facilitate the approval and/or settlement of a proposed transaction. In certain embodiments, a proposed transaction may be routed to an issuer system via a suitable transaction network (e.g., a debit network, a credit network, etc.), and the issuer system may evaluate the proposed transaction. The issuer system may then facilitate the settlement of the proposed transaction. In certain embodiments, an issuer system may include similar components as those discussed above for the mobile device 104. For example, an issuer system may include any number of processors, memories, input/output interfaces, and/or network/communication interfaces.

The service provider system 102 may include any number of service provider computers and services. A service provider computer may provide a wide variety of transaction-related and/or value-added services (VAS) associated with transactions, such as coupon redemption services, loyalty services, location-based services, electronic receipt services, product registration services, warranty services, coupon issuance services, and/or the routing of a proposed transaction to an issuer for approval and/or settlement purposes. For example, a service provider computer may include any number of processors, memories, input/output interfaces, and/or network/communication interfaces.

In certain embodiments, communications between the service provider system 102 and one or more consumer mobile devices 104 may be facilitated by one or more networks 110. Further, payment may be facilitated between the consumer mobile device 104 and a merchant point of sale (POS) device 108.

A wide variety of suitable networks, such as networks 110, which may be the same or separate networks and/or communication channels may be utilized to facilitate communications between the customer mobile devices 104, the service provider system 102, the POS devices 108, and/or other components of the system 100.

These networks 110 may include wireless networks, radio frequency (RF) networks, Bluetooth-enabled networks, near-field communication (NFC) connections, etc. Due to network connectivity, various methodologies as described herein may be practiced in the context of distributed computing environments. It will also be appreciated that the various networks may include a plurality of networks, each with devices such as gateways and routers for providing connectivity between or among networks. Additionally, instead of, or in addition to, a network, dedicated communication links may be used to connect various devices in accordance with an example embodiment.

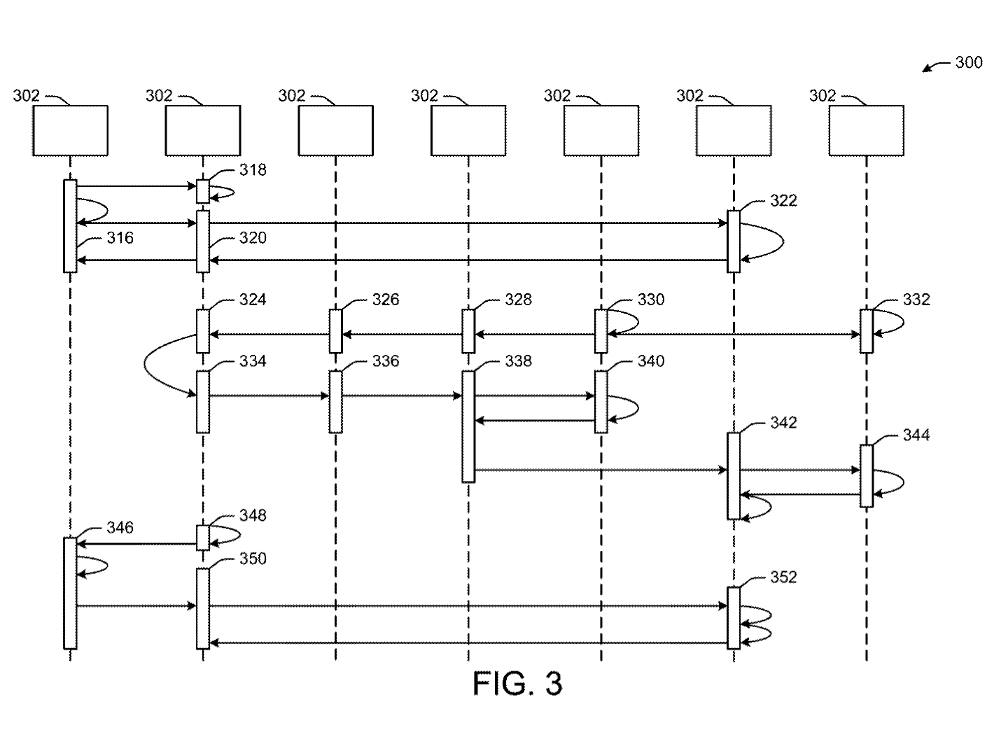

A wide variety of suitable networks 110 may be utilized in association with embodiments of the disclosure. Certain networks may facilitate communication between remote devices. For example, one or more telecommunication networks, cellular networks, wide area networks (e.g., the Internet), and/or transaction networks (e.g., branded networks (e.g., STAR network, Visa network, etc.), debit and/or PIN networks, and/or a wide variety of other suitable transaction networks) may facilitate communication between various components of the system 100. Further, according to some embodiments of the disclosure, encrypted channels 106 may be created to facilitate secure payment transactions. Further discussion of encrypted channels will be described in FIG. 3.

In reference to FIG. 1, the service provider system 102 may facilitate payment from a consumer mobile device 104. Payment information may include, but is not limited to, information associated with banking or payment information from a user associated with the one or more consumer mobile devices 104. For example, a consumer may have payment information such as a number of credit cards, debit cards, and bank accounts, etc. The service provider system 102 may store the payment information of a user. The service provider system 102 may store the payment information from a number of users in an encrypted database 112. The encrypted database 112 may contain many data files where the data stored in the data files are encrypted.

It should be appreciated that any number of service provider systems 102 may be present. A service provider system 102 may include any number of processor-driven devices, including, but not limited to, a server computer, a personal computer, one or more networked computing devices, an application-specific circuit, a minicomputer, a microcontroller, and/or any other processor-based device and/or combination of devices. The service provider system 102 may utilize one or more processors 114 to execute computer-accessible instructions (e.g., computer-readable instructions and/or computer-executable instructions) that can permit the general operation of the service provider system 102.

In addition to having one or more processors 114, the service provider system 102 may further include one or more memory devices (generally referred to as memory 120), one or more input/output (I/O) interface(s) 116, and/or one or more communication connections 118. The communication connections 118 may interface with the network 110 to establish an encrypted channel 106. The memory 120 may be any computer-readable medium, coupled to the one or more processors 114, such as random access memory (RAM), read-only memory (ROM), and/or removable storage devices. The memory 120 may store one or more program modules utilized by the service provider system 102, such as an operating system (OS) 122. The one or more program modules may include a consumer account module 124, an encryption module 126, a payment module 128, a tokenization module 130, and a dynamic track module 132.

Certain embodiments may be provided as a computer program product including a non-transitory machine-readable (e.g., computer-readable) storage medium having stored thereon instructions (in compressed and/or uncompressed form) that may be used to program a computer (or other electronic computing device) to perform one or more of the techniques (e.g., processes or methods) described herein. For example, certain embodiments may be provided as a computer program product or group of products that may be executed by the service provider system 102 or other suitable computing systems. The machine-readable storage medium may include, but is not limited to, hard drives, floppy diskettes, optical disks, CD-ROMs, DVDs, ROMs, RAMs, EPROMs, flash memory, magnetic or optical cards, solid-state memory devices, or other types of media/machine-readable mediums suitable for storing electronic instructions. Further, embodiments may also be provided as a computer program product including a transitory machine-readable signal (in compressed or uncompressed form). Examples of machine-readable signals, whether modulated using a carrier or not include, but are not limited to, signals that a computer system or machine hosting or running a computer program can be configured to access, including signals downloaded through the Internet or other networks.

With reference to the information retained in the memory 120, the operating system (OS) 122 may be any suitable module that facilitates the general operation of the service provider system 102, as well as the execution of other program modules. The one or more program modules, such as a consumer account module 124, may include one or more suitable software modules and/or applications configured to facilitate the management of consumer accounts.

With further reference to the contents of the memory 120, the consumer account module 124 may facilitate transactions and the management of payments for one or more user accounts associated with the consumer mobile device 104. The consumer account module 126 may manage user profile information such as payment account information, transaction processing information, user identification information, and authentication information for the consumer mobile device 104.

An encrypted channel 106 may be created to permit or otherwise facilitate the interaction between the consumer mobile device 104 and the service provider system 102. The service provider system 102 may utilize the network 110 to transport data, and encryption protocols in order to create the encrypted channel 106 between one or more consumer mobile devices 104 and the service provider system 102. The the service provider system 102 may be configured to maintain the security of consumer information (e.g., consumer data, consumer metadata, and/or consumer signaling) and also maintain the security of payment information (e.g., payment data, payment metada, and/or payment signaling) as such information are transported to or from, and/or are stored on the consumer mobile device 104. Maintaining security may include, but is not limited to:
a. Preventing unauthorized third parties from acquiring data that is stored on the service provider system 102 or any database or storage associated with the service provider system 102.
b. Preventing unauthorized third parties from procuring or acquiring the data during transmittal between the service provider system 102 and another computational device.
c. Authenticating the receiving device of the data to ensure that the data is disseminated to an authorized user or authorized third parties.

An encrypted channel 106 or substantially any secured channel may permit secure transport of information during communication between the consumer mobile device 104 and the service provider system 102. Accordingly, in one aspect, the encrypted channel 106 can effectively protect the information. The creation of an encrypted channel 106 is discussed in connection with FIG. 3.

The consumer account module 124 may manage the user accounts and payment information, and other transaction information. The consumer account module 124 may be a hardware, software or firmware implementation configured for managing accounts and/or payment information from a consumer. A software or firmware implementation of the consumer account module 124 may include computer-executable or machine-executable instructions written in any suitable programming language to perform the various functions described herein. In one embodiment, for example, the consumer account module 124 may interface with a consumer mobile device 104 to create user accounts, associate payment information, manage consumer mobile devices associated with the user accounts, provide authentication and validation for user accounts, facilitate authentication and validation of one or more consumer mobile devices 104 associated with the user accounts, facilitate payment transactions, or facilitate payment transactions to POS devices 108.

In at least one embodiment of the system 100, the consumer account module 124 may receive a request from a new user or an existing user to create an account for the user that originates the request, the account can permit or otherwise facilitate remote transactions from consumer mobile devices. The request may be received via a website, a mobile application available on a consumer mobile device 104, a transmission to a third-party system, such as a bank, a payment facilitation system, etc. The website may permit the users to interact with the service provider system 102 and to access various user accounts associated with the consumer mobile device 104.

In one non-limiting example, a consumer may register or create an account with the service provider system 102 through a graphical user interface (GUI) application. In certain embodiments, the GUI application may be a web browser, a mobile application, a dedicated application, or any way of accessing a website. Accordingly, in one aspect, the user application may provide and receive hypertext transfer protocol (HTTP) requests and/or responses from a server, such as the service provider system 102. In some examples, the website may be hosted by the service provider system 102 or any other third-party web server. The consumer may be presented with a GUI that may provide a home screen or landing webpage, where the user may interact with user profiles, account registration, services offered, and/or other information available via the website. In addition or in the alternative, the GUI may be configured to display information indicative or otherwise representative of one or more features of the user account. The user may create a log-in or other identifying credentials. The user may further input information such as a name, a mobile telephone number, an email or messaging address, consumer mobile device identifying information, social security numbers, and/or payment methods.

In connection with the consumer account module 124, in response (e.g., upon or after) creation of a user account, the service provider system 102 may transmit a prompt for the consumer mobile device 104 to enter a security code or a personal identification number (PIN) number associated with the user account. The service provider system 102 may further transmit a public key (e.g., an information object, such as data structure, communicable without encryption (informally referred to as “in the clear”) to the consumer mobile device 104 in order to create an encrypted channel 106 or any other secured channel for future PIN entries and/or verification. Further, security codes or PINs (e.g., an mPIN) associated with the user account may be retained in the encrypted database 112. The encrypted database 112 may be encrypted using software, hardware, and/or firmware-based encryption. The encrypted database 112 may utilize or otherwise leverage any suitable encryption protocols and/or techniques. The encryption may be rely on a symmetric key, an asymmetric key, or any other known encryption technique.

In at least one embodiment of the disclosure, information (e.g., data, metadata, and/or signaling) indicative or otherwise representative of payment methods may be retained by the service provider system 102. Payment method information may be further stored in an encrypted database 112 integrated into or functionally coupled to the service provider system 102. Inputting payment methods may include adding one or more bank account numbers, which may include checking account numbers, saving account numbers, credit card numbers, and/or debit card numbers. In certain implementations, the consumer can charge, load, or otherwise authorize an account utilized for payment with prepaid values. As an example, if a consumer intended to use one of the payment methods to make a payment, the consumer mobile device 104 may be prompted to enter a security code or PIN. In response (e.g., upon or after) entry, an encrypted channel 106 may be created between the consumer mobile device 104 and the service provider system 102. The consumer mobile device 104 may receive a selection of available payment methods and may utilize the payment methods to make a payment. In other illustrative embodiments of the disclosure, information indicative or otherwise representative of payment methods may be stored on the consumer mobile device 104. The service provider system 102 may provide secured access into at least a portion of the information (e.g., payment data, payment metadata, and/or payment signaling) that is retained on the consumer mobile device 104. The consumer mobile device 104 can be identified in a several ways. For example, the consumer mobile device can be identified based at least in part on one or more identifiers including one or more of a mobile phone number, an IMEI, a MEID, an MSISDN, a cellular device ID, a MAC address, a IP address, a combination thereof, or the like. Further, the consumer may be associated with any number of consumer mobile devices 104. A security code or PIN associated with the account may be utilized to unlock or access one or more payment methods stored on the consumer mobile device 104. As an example, if a consumer intended to use one of the payment methods to make a payment, the consumer mobile device 104 may be prompted to enter the security code or PIN. In response to (e.g., upon or after) entry, an encrypted channel 106 or otherwise any other secured channel may be created between the consumer mobile device 104 and the service provider system 102. The service provider system 102 may transmit a decryption key or an access code to the consumer mobile device 104, which can retain the decryption key or the access code in the memory 120.

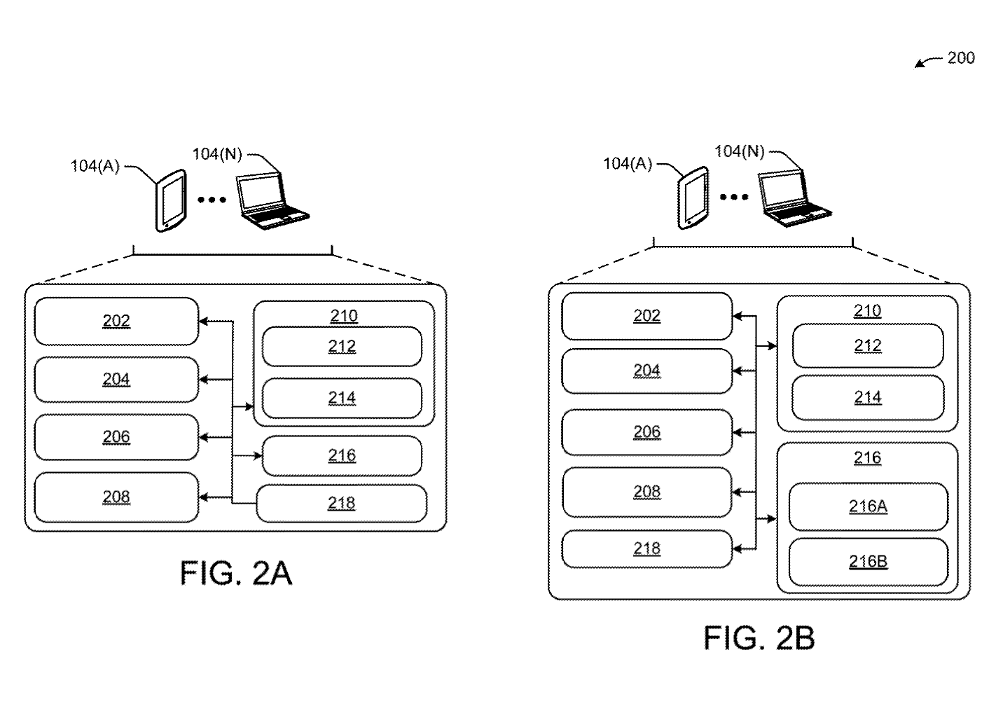

Illustrative functionality of and related example operations that may be performed by the consumer module 126 and/or the consumer mobile device 104 are described in greater detail below with reference to FIGS. 2A-2B and FIGS. 3-5.

In certain implementations, the encryption module 126 may be used to create an encrypted channel 106 for the secure communication of information with the consumer mobile device 104 and also the encryption and secure storage of encrypted data. The encryption module 126 may utilize, access, or otherwise communicate with an encrypted database 112. The encryption module 126 can be implemented as either software or hardware, and in yet another embodiment, a combination of software and hardware. The encryption module 126 may transmit a public key to generate an encrypted channel 106. The encrypted module 126 may generate an encryption key for encrypting or otherwise securely storing the security PIN. Further, the encryption module 126 may generate one or more decryption keys for decrypting information (data, metadata, and/or signaling) either stored in the encrypted database 112 or one of the customer mobile devices 104. A few examples of the operations that may be performed by the encryption module 126 and/or the consumer mobile device 104 are described in greater detail below with reference to FIG. 3.

The payment module 128 may include one or more suitable software modules and/or applications configured to transmit payment information and facilitate payment on behalf of the consumer mobile device 104. The payment module 128 may additionally facilitate the identification of a wide variety of payment information or payment data to be communicated to the POS device 108. According to an aspect of the disclosure, the payment information may include information associated with a payment account to be utilized in association with a payment transaction, such as a payment account number. In one example embodiment, the payment information may include track one and track two data, such as the data that may be stored by a conventional magnetic stripe payment device. Additionally, in certain embodiments, the payment information may include a wide variety of other transaction-related information, such as consumer identification information, consumer device identification information, coupons and/or offers to be redeemed, loyalty information (e.g., a loyalty account number, if available), electronic receipt preferences, warranty preferences, product registration preferences, etc.

In at least one illustrative embodiment of the disclosure, the payment module 128 may be utilized to transmit payment to a POS device 108. The payment module 128 may receive a request from a consumer mobile device 104. The request may be accompanied by a security code or a PIN. Further, the request may contain identifying information from the consumer mobile device 104. The payment module 128 may authenticate the consumer mobile device 104 associated with the user account. Upon authentication, the payment module 128 may transmit a list to the consumer mobile device 104 listing various payment methods for the consumer. The payment module 128 may receive a selection of the payment method. Details regarding the payment method may be retrieved from the encrypted database 112. The payment module 128 may transmit this information to the consumer mobile device 104. In other embodiments, the payment information may be tokenized and/or dynamic tracks may be created prior to transmission to the consumer mobile device 104. For example, the consumer might select a particular credit card account. The credit card data may be retrieved from the encrypted database 112. In one embodiment, the payment module 128 may transmit this data to the consumer mobile device 104. In other embodiments, the payment information may be tokenized. Further, in other embodiments, dynamic tracks may be created prior to transmission.

A few examples of the operations that may be performed by the payment module 128 and/or the consumer mobile device 104 are described in greater detail below with reference to FIGS. 2A-2B.

The tokenization module 130 may receive a request for tokenization. The request for tokenization may be originated from the payment module 128 or from the consumer mobile device 104. The request may identify a payment account or a credit card number. The tokenization module 130 may create a one-time use credit card in association with the payment account. Generally, bank card numbers are allocated in accordance with many rules and standards. The bank card number identifies the card, which is then electronically associated with a particular consumer and also with the consumer's designated payment account or bank account. The tokenization module 130 may generate a credit card number based at least in part on the rules associated with generating the credit card number. Further, the tokenization module 130 may generate further checksums or other algorithms to identify and authenticate the generated credit card number. In one embodiment, the security code may be used as an input. The tokenization module 130 can create an encrypted card number and related data that can be conveyed in Track 1 and Track 2 card data formats. In one aspect, such tokenized Track data can be decrypted algorithmically, with possession of suitable cryptography keys, in order to recover or otherwise obtain the original card data that was utilized to create or otherwise generate a token.

A few examples of the operations that may be performed by the tokenization module 130 and/or the consumer mobile device 104 are described in greater detail below with reference to FIGS. 2A-2B.

Dynamic track module 132 may be utilized to create dynamic tracks of the payment information. In certain embodiments, it should be appreciated that the term “track” in a dynamic track refers to Track 1 and Track 2 data, which are well-known standard formats for encoding payment card information into a magnetic stripe present on a surface of most physical payment cards (e.g., plastic payment cards, such as credit card of debit cards). Such data can be static, e.g., what is written into the magnetic stripe is what gets presented to the merchant POS every time the cardholder swipes the physical payment card at the POS reader. In addition, the term “dynamic” in a dynamic tracks refers to utilization of tokenized card data in creation of a single-use encrypted version of the static card data included in the creation or otherwise generation of Track 1 and Track 2 formatted data, where the tokenized data can change with each use of the consumer mobile device 104 to make a payment. Payment information may be received from the payment module 128. In other embodiments, the dynamic track module 132 may receive a tokenized version of the payment information from the tokenization module 130. In yet other embodiments, the dynamic track module 132 may receive payment information from a consumer mobile device 104. Credit cards generally can have magnetic stripes (for example, imprinted on a surface of the card) comprising credit card account information and/or payment information (such as credit limit of the credit card account). For example, in response to a credit card being swiped through a card reader (such as a POS device 108) or any other device that can access information encoded or otherwise retained in the magnetic stripe, a signal can be created and transmitted to the POS device 108. In one embodiment, for example, the signal may be an analog signal, even though digital signals also may be generated. The dynamic track module 132 may generate the analog signal that is indicative or otherwise representative of the information in a traditional credit card. Such signal may be transmitted to the consumer mobile device 104. In such embodiment, for example, the analog signal may be transmitted (e.g., relayed) to the POS device 108 from the consumer mobile device 104. In one embodiment, the dynamic track module 132 may transmit encrypted data within the analog signal. The consumer mobile device 104 can decrypt the encrypted data and can generate a signal indicative or otherwise representative of information (e.g., data, metadata, and/or signaling) included in a payment account. In some embodiments, the encrypted data contained within the analog signal may be referred to as a dynamic track cryptogram (DTC). As described herein, in certain embodiments, the dynamic track module 132 can generate a digital signal instead of an analog signal, where the digital signal be processed similarly to the manner in which the described analog signal is processed.

A few examples of the operations that may be performed by the dynamic track module 134 and/or the consumer mobile device 104 are described in greater detail below with reference to FIGS. 3-5.

The system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the disclosure should not be construed as being limited to any particular operating environment, system architecture, and/or device configuration.

FIGS. 2A-2B are illustrations of schematic block diagrams of example consumer mobile devices 104. FIG. 2A is an example consumer mobile device with a software or firmware implementation of a secure element, according to at least one embodiment of the disclosure. FIG. 2B is an example consumer mobile device with a hardware or digital circuitry implementation of a secure element, according to at least one embodiment of the disclosure. One will recognize from FIGS. 2A and 2B that a secure element for a consumer mobile device can be implemented as either software or hardware, and in yet another embodiment, a combination of software and hardware. The consumer mobile device 104 may refer to any mobile device that is operable to request the completion of a payment transaction. Examples of mobile devices include, but are not limited to, cellular phones, smartphones, personal digital assistants, pagers, digital audio players, handheld portable computers, digital tablets, laptop computers, etc. Additionally, for purposes of the present disclosure, the terms “mobile device,” “mobile communications device,” “mobile phone,” “cellular phone,” and “cell phone” may be used interchangeably.

Common to both FIGS. 2A and 2B are components of an example consumer mobile device 104, which can include one or more processors 202, input/output interfaces 204, communication connections 206, data storage, 208, one or more memory devices 210, and a short-range radio connection 218.

The short-range radio connection 218 may include any hardware to enable short-range radio communications such as such as NFC, RF, and/or BLUETOOTH and/or other functionality.

The consumer mobile device 104 may include one or more processors 202. The one or more processors 202 may be implemented as appropriate in hardware, software, firmware, or combinations thereof Software or firmware implementations of the one or more processors 202 may include computer-readable or machine-readable instructions written in any suitable programming language to perform the various functions described. The consumer mobile device 104, in addition to having processors 202, may have one or more input/output (I/O) interface(s) 204, one or more memory devices 210 (generally referred to as memory 210), and/or one or more communication connections 206. The communications connections 206 may interface with the network 110 (referred to in FIG. 1) to communicate data provided for remote payment transactions.

With continued reference to FIGS. 2A-2B, the I/O interfaces 204 may include, but are not limited to, a display, a keypad, a stylus, a keyboard, a haptic input device, a touch screen display, a microphone, a speaker, a mouse, or any other similar device that can facilitate user interaction.

With continued reference to FIGS. 2A-2B, the memory 210 may be any computer-readable medium, coupled to the one or more processors 202 of the consumer mobile devices 104. Examples of these memory mediums may include RAM, ROM, and/or removable storage devices. The memory 210 may store one or more program modules utilized by the consumer mobile device 104, such as an operating system (OS) 212. The one or more program modules may include a payment transaction module 214 among others.

The payment transaction module 214 may be a hardware, software, or firmware implementation configured for managing accounts and payment information on a consumer mobile device 104. A software or firmware implementation of the payment transaction module 214 may include computer-executable or machine-executable instructions written in any suitable programming language to perform the various functions described herein. The payment transaction module 214 may facilitate or control the transmission of the payment information to a third party, such as a POS device 108, and the processing of the transaction information to complete a transaction. Additionally, in certain embodiments, the payment transaction module 214 may facilitate the receipt of user input associated with a proposed transaction, such as the receipt of security information (e.g., a personal identification number (pin), a security code known as an mPin, biometric security information, etc.),a selection of a payment account by the consumer mobile device 104, the input of various transaction amounts by the consumer (e.g., a tip amount), the selection of coupons and/or rebate offers by a consumer, and/or the receipt of a transaction approval by a consumer of a consumer mobile device 104.

With respect to FIG. 2A, the payment transaction module 214, upon validation, may prompt a user to select a payment method. Upon selection of the payment method, the payment transaction module 214 may utilize the secure element module 216 to temporarily store data, create dynamic tracks, and tokenize and transmit the payment information to a POS device 108.

In one embodiment, the secure element module 216 may facilitate the access of user account and payment information. The secure element module 216 can be a software or firmware implementation and may include computer-executable or machine-executable instructions written in any suitable programming language to perform the various functions described herein. The operations of the secure element module 216 may be implemented after the usage of the payment transaction module 214. The secure element module 216 may permit or otherwise facilitate transmission of payment information from a consumer mobile device 104 to a POS device 108. The secure element module 216 may be validated through the use of a security code (e.g., a PIN, such as mPIN). The security code may be transmitted to the service provider system 102 using an encrypted channel 106. In response to validation (e.g., upon or after validation), the secure element module 216 may be configured to receive payment information from the service provider system 102. The service provider system 102 may transmit payment information through the use of dynamic tracks. The secure element module 216 may then receive data with the payment information. Further, upon receiving the data regarding the payment method, the secure element module 216 may facilitate the transmission to a merchant POS device 108 via, for example, a short-range radio technology, such as BLUETOOTH, Near Field Communication (NFC), or other radio technologies.

In at least one embodiment of the disclosure, the secure element module 216 may receive the payment information from the service provider system 102. However, the secure element module 216 may create dynamic tracks, and tokenize or otherwise encrypt the payment information prior to transmission to the POS device 108.

Other examples of the usage of the secure element module 216 may be provided for in further detail in reference to FIGS. 3-5.

With respect to FIGS. 2A and 2B, the payment transaction module 214, upon validation, may prompt a user to select a payment method. Upon selection of the payment method, in FIG. 2B the payment transaction module 214 may utilize the secure processor 216A to retrieve payment information, create dynamic tracks, and tokenize and transmit the payment information to a POS device 108.

As shown in FIG. 2B, the consumer mobile device 104 may be further configured with an encrypted data storage 216B. The encrypted data storage 216B may be any computer-readable medium, coupled to the one or more secure processors 216A of the consumer mobile device 104 such as RAM, ROM, and/or removable storage devices. The encrypted data storage 216B may be configured to store data in an encrypted format. For example, a consumer's payment information may be stored on the encrypted data storage 216B.

In one embodiment, the data may be decrypted using a symmetric key encryption/decryption scheme. The symmetric key may be generated utilizing a security code or PIN as an input. In some embodiments, the symmetric key may be stored remotely on the service provider system 102. The consumer mobile device 104 may retrieve the symmetric key and provide it to the secure processor 216A. The secure processor 216A may then decrypt the stored payment information and transmit at least a portion of the information that is decrypted to a POS device 108 via the short-range radio connection 218. In another embodiment, the secure processor 216a may receive a decryption key through the encrypted channel 106.

The example system shown in FIGS. 2A-2B is provided by way of example only. Numerous other operating environments, system architectures, and device configurations are possible. Accordingly, embodiments of the present disclosure should not be construed as being limited to any particular operating environment, system architecture, or device configuration.

FIG. 3 illustrates a call flow indicative of an example method 300 for managing one or more credentials for secure transactions according to at least one embodiment of the disclosure. As illustrated, the example method may include there logical blocks or operational stages: (1) generation of a user profile and/or credential(s) for secure transactions; (2) generation or configuration of a secured (e.g., encrypted) communication channel for the secure transactions; and (3) update of the credential(s). In certain embodiments, a mobile device associated with logical block (1) can be configured with encrypted hardware. The example method 300 may be performed by the service provider system 102 and/or one or more certain components therein of functionally coupled thereto, including, but not limited to, the encryption module 128, shown in FIG. 1 of the service provider system 102. Further, portions of the example method 300 may be performed by any or combinations of the consumer mobile device 104, the secure processor 216A, the encrypted data storage 216B, the secure element module 216, and the payment transaction module 214 of the consumer mobile device 104. In one embodiment, to maintain the security of the data transmitted on the encrypted channel 106, a unique key may be derived for each communication session between the service provider system 102 and the consumer mobile device 104.

(1) Generation of a user profile and/or credential(s) for secure transactions.—At block 316, a consumer device 302 (also referred to as a consumer 302) can render or otherwise provide a prompt an end-user associated with the consumer device 302 to create or add a user account, and/or register a consumer mobile device 104. It should be appreciated that the consumer device 302 may embody or can comprise the consumer mobile device 104. In one implementation, the consumer mobile device 104 may utilize the payment transaction module 214 to prompt the end-user to create a new account or authorize the consumer mobile device 104 to interact with an existing account. In other implementations, for example, new end-users can enroll to a digital wallet service by using a website or other interface in order to create a user account. In one aspect, an end-user may register and, as part of registrations, the end-user may create a usernames, a password and/or a security code, or other credentials for identification and/or implementation of secure transactions.

As illustrated, the consumer 302 transmits information indicative of addition or access to an account to a wallet component 304 (also referred to as wallet 304 or widget 304). In response, at block 318, the wallet 304 can render indicia indicative or otherwise representative of a prompt for selection of a credential, such as a security code (e.g., an mPIN). In response to such indicia (referred to as “a prompt for credential selection”), the consumer 302 can determine (e.g., select) a specific credential (e.g., a specific security code, such as an mPIN) at block 316. In certain embodiments, to permit or otherwise facilitate providing a credential, such as a security code, the consumer 302 can receive credential information indicative of the selection of the credentials via an input device, such as a keyboard or a touch screen-generated keyboard on a device with a touch screen, integrated into the consumer device 302 or functionally coupled thereto. The consumer 302 can transmit at least a portion of the credential information, illustrated as “mPIN entry” in FIG. 3, to the wallet 304. A credential, e.g., a security code, may comprise any ASCII characters, such as alphanumeric symbols, non-alphanumeric symbols, combinations thereof, and the like. Further, the credential, e.g., the security code, may comprise or may be embodied in a string of ASCII characters having substantially any length.

At block 320, the wallet 304 can receive at least the portion of the credential information indicative of a selected credential (e.g., a security code, such as an mPIN entry), and can relay (e.g., transmit without substantive modification) the credential information that is received (e.g., information indicative of the security code) to a processing and validation platform 312 that, for example, can embody or can comprise an issuer or a DTC processor entrusted with DTC and mPIN validation. In one implementation, the credential information (e.g., the information indicative of the security code) may be transmitted utilizing the encrypted channel 106 of the service provider system 102.

At block 322, the processing and validation platform 312 can authorized the mobile device 104 for secure transactions in response to verification of the end-user account and/or associated information. In one aspect of authorization, the credential information (e.g., the information indicative of the security code) that is received at the processing and validation platform 312 can be retained in the encrypted database 112 associated with the service provider system 102.

It should be appreciated that, in certain embodiments, the operations associated with the logical block (1) may be modified in various ways in accordance with certain embodiments of the disclosure. For example, one or more operations may be eliminated or executed in an order that is different from the order that is illustrated in FIG. 3. Additionally, other operations may be added in accordance with other embodiments of the disclosure.

(2) Generation of a secured channel for secure transactions.—At block 330, the account transaction service (ATS) hardware security module (HSM) 310 can generate or otherwise access one or more public and private keys. The ATS HSM 330 can be or can comprise a tamper-resistant cryptography module having a specific or otherwise well defined and hardened interface. Such module can be configured or otherwise assembled to perform cryptography computations, such as encryption and/or decryption, without exposing clear information (e.g., text values) associated with a keys or a message outside the HSM device. HSM is a well-known industry standard term for such cryptography devices. In addition, the ATS HSM 310 can transmit at least one of the public or private keys to a DTC HSM 314. In one aspect, as described herein, the DTC can be a cryptogram that can be generated anew for each transaction, can be transported in Track 1, and can be validated by the processing and validation platform 312 (such as an issuer or an issuer processor) for the purpose of authenticating a consumer for a respective transaction. Such keys may include base derivation keys (BDKs). The BDK may be or may comprise a string of characters having substantially any length. The BDK may be stored in the encrypted database 112 of the service provider system 102. Further, the BDK may be stored in any tamper-resistant security database or storage (e.g., memory device or repository device), such as one or more memories that may be provided by the service provider system 102. One or more BDKs may be utilized with any known encryption protocol to create the transportation key or the initial PIN encryption key (IPEK). In one example, the BDK may be stored in the encryption module 128 utilizing a symmetric key encryption algorithm, such as the 3DES encryption algorithm. The 3DES encryption algorithm may encrypt a plain text element three times using the symmetric key. In some examples, the symmetric key may be stored in the hardware of the encryption module 128. The BDK may be decrypted by the service provider system 102 or the processor associated with the service provider system 102.

An IPEK may be generated based at least in part on the BDK. The IPEK may be generated by utilizing any encryption protocol and the BDK as the cipher text. In some embodiments, the IPEK may be utilized to create a public key and may be transmitted to the consumer mobile device 104. In other embodiments, the IPEK itself may be the public key. The service provider system 102 may utilize any known public key (asymmetric) generation method or protocol such as the RSA to generate the public key. The IPEK may be either discarded after the session or alternatively be stored as a “discarded” key for further security.

An IPEK or “future key” (also known as the “public key”) may be transmitted to the consumer mobile device 104. The public key may be transported to the consumer mobile device 104 utilizing the network 110. The public key may be any string, character, image, or data of any length.

At block 334 the payment transaction module 304 can generate a security code cryptogram and an account identifier pair. The account identifier may be any string uniquely identifying the consumer device 302 (e.g., a consumer mobile device 104) or an end-user account associated with the consumer device 302. In one embodiment, the payment transaction module 304 may generate such pair by encrypting the account identifier utilizing the public key as the asymmetric encryption key and any known protocol such as the RSA. In addition, at block 334, the mPIN or the security code may be padded and encrypted. A padding string may be generated by the consumer mobile device 104, according to an encryption protocol or algorithm in agreement or in consortium with the security device. The padding may be utilized to prevent a dictionary attack. For example, if all of the security codes are four characters in length, and if the same encryption protocol is utilized to encrypt the plaintext of the security code, then security code may be always mapped to the same encrypted text. For example, if a security code is “1234” and the encryption protocol always returns the encrypted text of “9876,” it is possible for a third-party eavesdropper to collect all of the possible encryption texts and map them into a plaintext security to decipher the security code. Therefore, the padding may ensure that the security code is mapped to a different encryption text each time the encryption protocol is utilized. The encryption text may be generated by utilizing the public key as the asymmetric encryption key, and the padded mPIN text as the clear-text message and any known asymmetric encryption protocol such as the RSA. The encryption text herein may be defined as “the security code cryptogram.”

In addition, the payment transaction module 304 can transmit such pair to a payment infrastructure 306 (also referred to as W/WI 306). The security code cryptogram and the account identifier can be transmitted to the payment infrastructure 306 via the network(s) 110 (not shown in FIG. 3). At block 336, the payment infrastructure 306 can relay the security code cryptogram and the account identifier to an account transaction service (ATS) 308. In turn, the ATS 308 can relay such pair to an ATS HSM 310. At block 340, the ATS HSM 310 can decrypt the security code cryptogram and the account identifier pair utilizing a private key associated with an IPEK and a BDK. In response to such decryption, the service provider system 102 may have the plaintext security code and the account identifier. In addition, the ATS HSM 310 can encrypt the security code, or any other credential that is received as part of the received pair, and can transmit the encrypted security code to the ATS 308. The encrypted information is referred to as encrypted credential block (e.g., an mPIN block).

At block 338, the ATS 308 can transmit the encrypted credential block to the processing and validation platform 312, which can retain the encrypted credential. In addition, at block 342, the processing and validation platform 312 can transmit the encrypted credential block to the DTC HSM 314. At block 344, the DTC HSM 314 can transform the encrypted credential block from a first encryption format (e.g., ANSI) to a second encryption format (e.g., 3DES) for encrypted storage. In addition, the DTC HSM 314 can transmit the credential block encrypted in the second format to the processing and validation platform 312 for encrypted storage.

At block 316, the user account may be verified utilizing the account identifier and the security code. The verification may be performed by comparing a stored version of the security code and the account identifier stored in the encrypted database 112 of the service provider system 102. If an unauthorized third party transmits requests to the service provider system 102 utilizing an unauthorized consumer mobile device 104, the decryption protocol may be unable to decrypt the pair such that both the security code and the account identifier are matched with the stored versions.

Once the user account and the consumer mobile device 104 have been verified at block 316, the consumer mobile device 104 may communicate further utilizing the generated security code and account identifier cryptogram pair and further encrypting the messages for this session. Upon, termination of this communication session, the public key and the IPEK may be destroyed or deactivated. Each transmission of data may be accompanied by a verification, as described in block 316.

(3) Update of credential(s) for secure transactions.—Credentials (e.g., secure codes) that can be generated in accordance with one or more aspects of the disclosure can be updated as described herein. In certain embodiments, the service provider system 102 and/or the consumer mobile device 104 that is authorized for utilization of secure transactions can updated a credential. At block 348, the wallet 304 can detect an event indicative or otherwise representative of an intended change to an existing credential (e.g., an mPIN) and, in response, the wallet 304 can cause the consumer device 302 (e.g., mobile device 104 that contains the wallet 304) to render indicia indicative of a prompt to change the existing credential. In one aspect, the consumer device 302 can render the prompt at block 346. The prompt can request an end-user associated with the consumer device 302 to provide (e.g., input) credential information indicative or otherwise representative of the existing credential (e.g., a security code). In an embodiment in which the consumer 302 is embodied in or comprises the consumer mobile device 104, the consumer 302 may have a touch-screen interface that can permit the end-user to enter at least a portion of the credential information. In addition or in the alternative, the end-user may input at least a portion of the credential information indicative of the existing credential (e.g., a security code) using a keyboard.

In addition, at block 346, the end-user associated with the consumer device 302 may be prompted for a new credential (e.g., a new security code). In response to receiving the new credential (e.g., the new security code), the credential may be validated against a set of rules or criteria. The prompt rendered by the consumer device 302 may indicate rules or other criteria for entering a new credential, such as PIN. Further, in some embodiments, the end-user may be prevented from entering a previously utilized credential (e.g., a PIN).

Moreover, at block 346, the consumer device 302 can communicate information indicative of the new credential and the existing credential to the wallet 304. At block 350, the wallet 304 can relay such information to the processing and validation platform 312. In one aspect, a cryptogram message utilizing the existing credential (e.g., existing PIN) as verification can be transmitted to the service provider system 102 via the secured channel, the service provider system 102 can embody or can comprise the processing and validation platform 312.

At block 352, the processing and validation platform 312 can validate the existing credential (e.g., an old mPIN). In certain implementations, the processing and validation platform 312 can discard or otherwise destroy the existing credential. In addition, at block 352, the processing and validation platform 312 can retain the new credential (e.g., a new mPIN). In one aspect, the new credential may be encrypted prior to being retained within the encrypted database 112.

It should be appreciated that, in certain embodiments, the operations associated with the logical block (3) may be modified in various ways in accordance with certain embodiments of the disclosure. For example, one or more operations may be eliminated or executed in an order that is different from the order that is illustrated in FIG. 3. Additionally, other operations may be added in accordance with other embodiments of the disclosure.

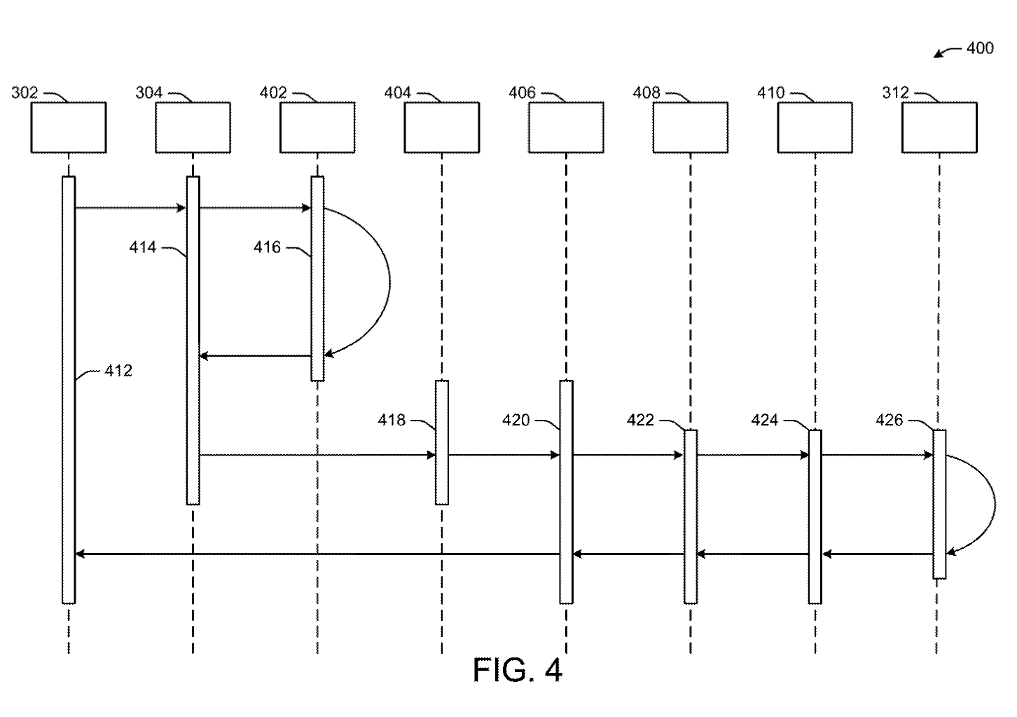

FIG. 4 presents a call flow diagram that illustrates an example method 400 for validating credentials during a transaction according to at least one embodiment of the disclosure. The example method 600 can represent an example method for conducting a payment transaction through a consumer mobile device 104 in accordance with at least certain aspects of the disclosure.

At block 412, the consumer device 302 can communicate information indicative of a credential (e.g., mPIN) to the payment module 304. At block 304, the payment transaction module 304 can relay (e.g., transmit without substantive modification) the credential (e.g., the mPIN) to a secure element module 402. As illustrated, at block 416 the secure element module 402 can receive the credential, and can generate one or more dynamic tracks as described herein. In one implementation, the dynamic track(s) can include information indicative or otherwise representative of a security code (e.g., an mPIN) for DTC. At least one of the dynamic track(s) can be encrypted. In certain embodiments, at least one or each of the dynamic track(s) can be generated in response to the credential being validated by the secure element module 402. As described herein, a dynamic track can be indicative or representative of payment account information accessible to the payment transaction module 304. Such information can be retained locally in the secure element module 402. A dynamic track can be representative or otherwise indicative of information contained in a physical magnetic track that may be located on a credit card or other financial instrument (e.g., a debit card). In addition, a dynamic track may emulate an analog (e.g, magnetic) signal that can be transmitted to a POS reader (e.g., POS reader 404). In addition, the secure element module 402 can communicate the dynamic track(s) to the payment transaction module 304.

At block 414, the payment transaction module 304 can transmit at least one of the dynamic track(s) to a POS reader 404. As described herein, the POS reader 404 can be embodied in or can comprise a NFC reader, a barcode reader, or a virtual reader. In certain embodiments, a device that contains the payment transaction module 304 can transmit the dynamic track to the POS reader 404 (e.g., POS device 108) via a short-range radio technology. At block 418, the POS reader 404 can relay the at least one of the dynamic track(s) to a POS terminal 406 (or a merchant network node). At block 420, the POS terminal 406 can transmit a purchase request to an acquiring processor 408. In one aspect, the purchase request can have at least one of the dynamic track(s) that are received from the POS reader 404. As illustrated, in one embodiment, the POS terminal 406, can communicate such request without information indicative of the credential (e.g., a PIN block) received at the payment module 304. The acquiring processor 408 can relay the purchase request to a payment network 410, which in turn can transmit the purchase request, including DTC, to the processing and validation platform 312.

At block 426, the processing and validation platform 312 can validate a user account via DTC validation, including validation of a credential associated with the purchase request, the credential obtained from the dynamic track(s) generated at block 402. In addition, in response to successful validation of the user account, the processing and validation platform 312 can transmit approval information (e.g., data, metadata, and/or signaling) indicative of approval of the purchase request to the payment network 410 (or a network node thereof). In response, at block 424, the payment network 410 can relay at least a portion of the approval information to the acquiring processor 408. In response, at block 422, the acquiring processor 408 can relay to the POS terminal 406 at least the portion of the approval information that is received. In response to receiving approval information, at block 420, the POS terminal 406 can transmit a receipt for the purchase transaction associated with the purchase request that is approved. The POS terminal 406 can generate the receipt. As illustrated, the receipt can include the last four digits of a dynamic personal account number (PAN).

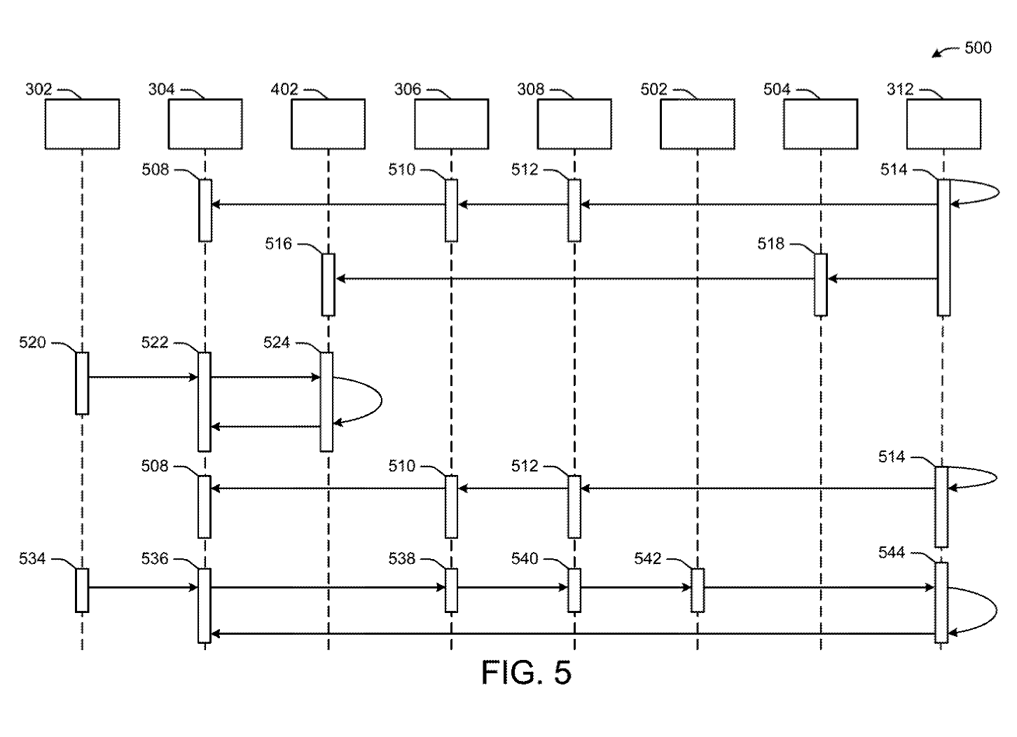

FIG. 5 presents a call flow diagram that illustrates an example method 500 for registration of an end-user account and tokenization of a portion of a transaction according to at least one embodiment of the disclosure. In one aspect, the registration can be implemented with or without a secure element (e.g., secure element module 216) in user equipment (wireless or tethered). As illustrated, registration of the end-user account, the processing and validation platform 312 can register such account and can provide registration information indicative of the end-user account (e.g., account status, account validity period, credential record(s) associated the account, combinations thereof, or the like) to the payment transaction module 304 and the secure element module 402. Communication of the registration information can be implemented via specific pathways for each of the payment transaction module 304 and the secure element module 402. In connection with the payment transaction module 304, at block 514, the processing and validation platform 312 transmits registration information to the ATS 308. In turn, at block 512, the ATS 308 transmits the registration information to the payment management infrastructure 306. At block 510, the payment management infrastructure 306 transmits the registration information to the payment transaction module 304. At block 508, the payment transaction module 304 can retain (e.g., store in a memory device, such as memory 210) at least a portion of the registration information. In connection with communication of account registration information the secure module element 402, at block 514, the processing and validation platform 312 can transmit the account registration information to a trusted service management (TSM) 504. The TSM can comprise one or more services suitable for provisioning payment accounts into a secure element (e.g., a secure chipset or a secure processor) of a mobile computing device or any other type of computing device. At block 518, TSM 504 transmits at least a portion of the account registration information to the secure element module 402. At block 516, the secure element module 402 can retain (e.g., store in a memory device, such as memory 210) at least a portion of the registration information.

Similarly, in certain embodiments, tokenization of payment information can be implemented in the presence of a secured element module 402. In such embodiments, at block 524, the secure element module 402 can generate one or more dynamic tracks, including encrypted data indicative of a credential (e.g., mPIN) associated with an end-user account. Each of the one or more dynamic tracks can include a tokenized representation of payment information associated with the end-user account. As illustrated, in order to generate the dynamic track(s), at block 520, the consumer device 302 can transmit credential information indicative or otherwise representative of the credential to the payment transaction module 304. At block 522, the payment transaction module 304 can receive the credential information (e.g., an mPIN) and, in turn, can relay at least a portion of the credential information to the secure element module 402. As described herein, the secure element module 402 can generate the dynamic track(s) as described herein, and can transmit at least one of the dynamic track(s) to the payment transaction module 304.

In other embodiments, tokenization of payment information can be implemented as a service, in the absence of a secure element module 402. In such embodiments, at block 534, the consumer device 302 can transmit credential information indicative or otherwise representative of a credential (e.g., mPIN) to the payment transaction module 304. At block 536, the payment transaction module 304 can transmit at least a portion of the credential information and other information comprising payment information associated with the end-user account to the payment management infrastructure 306. At block 538, in turn, the payment management infrastructure 306 can relay at least the portion of the credential information and the other information comprising payment information to the ATS 308. At block 540, the ATS 308 can relay such information to a tokenization service 502 that can tokenize (e.g., represent or otherwise indicate certain information via one or more tokens) at least the payment information that is received. At block 542, the tokenization service 502 can transmit tokenized payment information and credential information to the processing and validation platform 312. At block 544, the processing and validation platform 312 can generate one or more dynamic tracks, including the credential (e.g., the mPIN) for DTC. As described herein, in certain embodiments, a dynamic track may comprise information indicative of a magnetic signal that may be accessed via a physical credit card. In other embodiments, the processing and validation platform 312 can generate a dynamic track after or upon verification of the credential (e.g., an mPIN or a security code by the service provider system 102, the service provider system 102 may generate a dynamic track.

Based on the present specification and annexed drawings, various embodiments of the disclosure emerge. For example, in one embodiment, the disclosure can provide an example method for facilitating secure remote transactions comprising receiving, by a mobile device having at least one processor, a unique encryption key associated with a service provider system storing a payment account associated with a user of a mobile device; generating a cryptogram, by the mobile device, wherein the cryptogram comprises at least in part a security code and an identifier that uniquely identifies the payment account; transmitting, by the mobile device, the generated cryptogram; and receiving, by the mobile device, data associated with the payment account upon verification of the cryptogram.

In certain embodiments, the disclosure provides an example method for facilitating secure remote transactions comprising receiving, by a mobile device having at least one processor, a unique encryption key associated with a service provider storing the payment account associated with the user of the mobile device; generating a cryptogram (e.g., a DTC), by the mobile device, wherein the cryptogram comprises at least in part a security code and an identifier that uniquely identifies the payment account; transmitting, by the mobile device, the generated cryptogram; and granting, by the mobile device, access to data associated with the payment account upon verification of the cryptogram.

In one embodiment, the disclosure provides an example method for encrypting mobile device communications, the method comprising providing, by a first application stored on a first memory of a consumer mobile device, authentication information to a service provider system; receiving, by the first application, authorization from the service provider system based at least in part on the authentication information; transmitting, by the first application, a decryption key to payment data stored on a second memory of the mobile device, and receiving, by the first application, a decrypted payment data from the second memory. The decryption key comprises an asymmetric key. In certain implementations, the example computer-implemented method also can comprise generating, by the first application, the transmitted decryption key to the second memory.

In one embodiment, the disclosure provides an example payment processing system comprising a network interface communicating with a memory; the memory communicating with a processor for executing payments; and the processor, when executing a computer program, performing operations comprising: storing, by the processor and to a memory associated with the payment processing system, account information associated with the consumer mobile system; receiving, by the processor and from a consumer mobile device, a request, wherein the request comprises an account identifier associated with the consumer mobile device, validating, by the processor and from a consumer mobile device, the consumer mobile device based at least in part on the account identifier; and sending, by the processor, payment processing data, based on the validation.

In one aspect, in the example payment processing system, the payment processing data further comprises a magnetic signal identifying an account number associated with the payment processing data. In another aspect, in the example payment processing system of claim 6 wherein the payment processing data further comprises a generated one-time use code identifying an account number associated with the payment processing data.

In certain embodiments, the disclosure provides a mobile computing device comprising a first memory for storing data and computer-executable instructions, communicating with a first processor; a second memory for storing payment data, wherein the second memory is configured to encrypt the stored data; a second processor configured to decrypt and retrieve stored payment data from the second processor upon receipt of a decryption key; and a first processor, when executing computer-executable instructions, performing the operations comprising: receiving a validation code; transmitting the validation code, through a network communication interface, receiving the decryption key, through the network; and transmitting the decryption key to the second processor to enable decryption of the stored payment data.

In another embodiment, the disclosure provides an example system for payment transactions comprising a network interface communicating with a memory, the memory communicating with a processor for executing payments; and the processor, when executing a computer program (which can be retained in the memory), performing operations comprising: generating a unique encryption key, based at least in part on a user account associated with a consumer mobile device; receiving a cryptogram, generated at least in part using the unique encryption key, wherein the cryptogram comprises at least in part an account identifier identifying the consumer mobile device, and a security code; and performing a payment transaction associated with the user account based at least in part on validating the received cryptogram.

In one aspect, the processor is further operable to deactivate the unique encryption key upon completion of the payment transaction. The payment transaction further comprises receiving a request, wherein the request comprises at least in part an identified payment account, and transmitting a payment signal. In certain implementations, the payment signal comprises a Dynamic Transaction Cryptogram (DTC) configured to be transmitted to a magnetic reader on a point of sale device. In other implementations, the payment signal further comprises a unique number configured to emulate a credit card number associated with the payment account.

In one embodiment, the disclosure can provide an example payment processing system comprising a network interface configured to communicate with a memory having instructions encoded thereon; and a processor for executing payments, the processor is functionally coupled to the memory and configured, by the instructions, to receive a prompt to associate a consumer mobile device with an end-user account; to transmit a request to receive a security code for validating the consumer mobile device; to encrypt the security code for validating the consumer mobile device; and to retain the encrypted security code at the memory.

In one embodiment, the disclosure can provide an example method in accordance with various aspects. The example method can comprise receiving, at a computing device, one or more of a tokenized security credential or information indicative of an end-user account, wherein the information is tokenized information indicative of the end-user account; generating one or more dynamic tracks comprising an encrypted version of the security credential; and supplying at least one of the one or more dynamic tracks to a mobile computing device. The example method, also can comprise tokenizing, at another computing device, a security credential, thereby producing the tokenized security credential. In addition or in the alternative, the example method can comprise tokenizing, at another computing device, information indicative of the end-user account, thereby producing the tokenized information indicative of the end-user account.

In another embodiment, the disclosure can provide an example method that can comprise receiving, at a computing device, an asymmetric public key; receiving, at the computing device, a security credential; encrypting, at the computing device, the security credential based at least in part on the public key and a first encryption protocol; and supplying the encrypted security credential to a second computing device that generated the public key.

In one aspect, receiving the security credential comprises receiving a personal identification number from a mobile device. In another aspect, receiving the public key comprises receiving a 3DES public key. In yet another aspect, receiving the public key comprises receiving a PKI public key.

In certain implementations, the example method also can comprise receiving, at the second computing device, the encrypted security credential, and generating a second encrypted security credential based at least on a second encryption protocol and the encrypted security credential. The generating comprises translating the encrypted security credential into the second encrypted security credential in accordance with aspects described herein. The first encryption protocol comprises OEAP Padding and RSE encryption with asymmetric keys, and the second encryption protocol comprises 3DES encryption with symmetric keys. The second encryption protocol further comprises an ANSI PIN block.

In certain embodiments, the disclosure provides example methods (e.g., FIGS. 3-5). One or more of such methods can comprise receiving, at a computing device, a dynamic track comprising a security credential embedded into a dynamic track cryptogram; receiving a purchase request at the computing device; processing the purchase request at the computing device; and validating the DTC at the computing device.

In one embodiment, the disclosure can provide an example system for payment transactions. The example system for payment transactions can comprise at least one memory having computer-executable instructions encoded thereon; and at least one processor functionally coupled to the at least one memory and configured, by the computer-executable instructions, to receive one or more of a tokenized security credential or information indicative of an end-user account, wherein the information is tokenized information indicative of the end-user account; to generate one or more dynamic tracks comprising an encrypted version of the security credential; and to supply at least one of the one or more dynamic tracks to a mobile computing device.

The example system for payment transactions also can, comprise at least one other processor configured, by the computer-executable instructions, to tokenize a security credential, thereby producing the tokenized security credential. In addition or in the alternative, the example system for payment transactions can comprise at least one other processor configured, by the computer-executable instructions, to tokenize information indicative of the end-user account, thereby producing the tokenized information indicative of the end-user account.

In certain embodiments, the disclosure can provide an example system for transactions, such as financial transaction, payment transactions, commercial transactions, and the like. The example system can comprise at least one memory having computer-executable instructions encoded thereon; and at least one processor functionally coupled to the at least one memory and configured, by the computer-executable instructions, to receive an asymmetric public key; to receive a security credential; to encrypt the security credential based at least in part on the public key and a first encryption protocol; and to supply the encrypted security credential to at least one other processor that generated the public key.

In one aspect, in the example system for transactions, the at least one other processor is configured, by the computer-executable instructions, to receive the encrypted security credential, and further configured to generate a second encrypted security credential based at least on a second encryption protocol and the encrypted security credential. In another aspect, in such system the at least one other processor is configured to translate the encrypted security credential into the second encrypted security credential. In yet another aspect, the first encryption protocol comprises OEAP Padding and RSE encryption with asymmetric keys, and the second encryption protocol comprises 3DES encryption with symmetric keys. In addition or in the alternative, the second encryption protocol further comprises an ANSI PIN block.

In still another aspect, in the example system for transactions, receiving the security credential comprises receiving a personal identification number from a mobile device. In another aspect, in the example system for transactions, receiving the public key comprises receiving a 3DES public key. In a further or alternative aspect, receiving the public key comprises receiving a PKI public key.

In another embodiment, the disclosure provides an example apparatus. The example apparatus can comprise at least one memory having computer-executable instructions encoded thereon; and at least one processor functionally coupled to the at least one memory and configured, by the computer-executable instructions to receive a dynamic track comprising a security credential embedded into a dynamic track cryptogram; to receive a purchase request; to process the purchase request; and to validate the dynamic track cryptogram at the computing device.

References are made to the schematic block diagrams of systems, methods, and computer program products according to example embodiments of the disclosure. It will be understood that at least some of the blocks of the block diagrams, and combinations of blocks in the block diagrams, respectively, may be implemented at least partially by computer program instructions. These computer program instructions may be loaded onto a general purpose computer, a special purpose computer, a special purpose hardware-based computer, or other programmable data processing apparatus to produce a machine, such that the instructions which execute on the computer or other programmable data processing apparatus create means for implementing the functionality of at least some of the blocks of the block diagrams, or combinations of the blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the block or blocks.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and methods (or techniques) are described herein with reference to block diagrams and call flow illustrations of methods, systems, apparatuses and computer program products. It can be understood that each block of the block diagrams and call flow illustrations, and combinations of blocks in the block diagrams and call flow illustrations, respectively, can be implemented by computer-accessible instructions. In certain implementations, the computer-accessible instructions may be loaded or otherwise incorporated into onto a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “module” “interface,” “unit,” “pipe,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that provides, at least in part, the functionality of the electronic components. While the foregoing examples are presented in connection with a “component,” the same illustrations are applicable to the other computer-related entities or operational apparatuses described herein. An interface can include input/output (I/O) components as well as associated processor, application, and/or other programming components. The terms “component,” “environment,” “system,” “interface,” “unit,” “pipe,” and “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance the performance of user equipment or other electronic equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

One or more components of the systems and one or more elements of the methods described herein may be implemented through an application program running on an operating system of a computer. They also may be practiced with other computer system configurations, including handheld devices, multiprocessor systems, microprocessor-based or programmable consumer electronics, mini-computers, main computers, etc.

Application programs that are components of the systems and methods described herein may include routines, programs, components, data structures, etc., that implement certain abstract data types and perform certain tasks or actions. In a distributed computing environment, the application program (in whole or in part) may be located in local memory, or in other storage. In addition, or in the alternative, the application program (in whole or in part) may be located in remote memory or in storage to allow for circumstances where tasks are performed by remote processing devices through a communication network.

1. A payment processing system, comprising:
a network interface communicating with a memory;
the memory communicating with a processor for executing payments; and
the processor, when executing a computer program, performing operations comprising:
storing, by the processor and to a memory associated with the payment processing system, account information associated with the consumer mobile system;
receiving, by the processor and from a consumer mobile device, a request, wherein the request comprises an account identifier associated with the consumer mobile device,
validating, by the processor and from a consumer mobile device, the consumer mobile device based at least in part on the account identifier; and
sending, by the processor, payment processing data, based on the validation.

2. The payment processing system of claim 1, wherein the payment processing data further comprises a magnetic signal identifying an account number associated with the payment processing data.

3. The payment processing system of claim 1 wherein the payment processing data further comprises a generated one-time use code identifying an account number associated with the payment processing data.

4. A system for payment transactions comprising:
a network interface communicating with a memory;
the memory communicating with a processor for executing payments; and
the processor, when executing a computer program, performing operations comprising:
generating a unique encryption key, based at least in part on a user account associated with a consumer mobile device;
receiving a cryptogram, generated at least in part using the unique encryption key, wherein the cryptogram comprises at least in part an account identifier identifying the consumer mobile device, and a security code; and
performing a payment transaction associated with the user account based at least in part on validating the received cryptogram.

5. The system of claim 4, wherein the processor is further operable to deactivate the unique encryption key upon completion of the payment transaction.

6. The system of claim 4, wherein performing the payment transaction further comprises:
receiving a request, wherein the request comprises at least in part an identified payment account, and
transmitting a payment signal.

7. The system of claim 4, wherein the payment signal comprises a Dynamic Transaction Cryptogram (DTC) configured to be transmitted to a magnetic reader on a point of sale device.

8. The system of claim 4, wherein the payment signal further comprises a unique number configured to emulate a credit card number associated with the payment account.

9. A method, comprising:
receiving, at a computing device, an asymmetric public key;
receiving, at the computing device, a security credential;
encrypting, at the computing device, the security credential based at least in part on the public key and a first encryption protocol; and
supplying the encrypted security credential to a second computing device that generated the public key.

10. The method of claim 9, further comprising receiving, at the second computing device, the encrypted security credential, and
generating a second encrypted security credential based at least on a second encryption protocol and the encrypted security credential.

11. The method of claim 10, wherein the generating comprises translating the encrypted security credential into the second encrypted security credential.

12. The method of claim 10, wherein the first encryption protocol comprises OEAP Padding and RSE encryption with asymmetric keys, and the second encryption protocol comprises 3DES encryption with symmetric keys.

13. The method of claim 12, wherein the second encryption protocol further comprises an ANSI PIN block.

14. The method of claim 9, wherein receiving the security credential comprises receiving a personal identification number from a mobile device.

15. The method of claim 9, wherein receiving the public key comprises receiving a 3DES public key.
